(19) United States
(12) Patent Application Publication
(10) Pub. No.: US 2007/0221479 A1
(43) Pub. Date: Sep. 27, 2007

(54) Compression-Resistant Drive Chain for an Actuating Device

(75) Inventor: Karl-Heinz Schmezer, Georgsmarienhutte (DE)

Correspondence Address: GUDRUN E. HUCKETT DRAUDT, SCHUBERTSTR. 15A, WUPPERTAL, 42289, DE

(73) Assignee: Alexander Schmezer, Georgsmarienhütte (DE)

(21) Appl. No.: 10/599,605

(22) PCT Filed: Apr. 4, 2005
(86) PCT No.: PCT/EP05/03518

§ 371 Date: Oct. 3, 2006

(30) Foreign Application Priority Data
Apr. 5, 2004 (EP) 04008209.1

(51) Int. Cl. B65G 25/04

(52) U.S. Cl. 198/750.1; 198/618

(57) ABSTRACT

A compression-resistant drive chain for an adjusting device is provided with several chain links that are connected pivotably by connecting plates. These links are comprised of at least two swivel elements with bearing surfaces that in the longitudinal chain direction have at least over portions thereof a complementary shape with partial sliding surfaces having an arc contour. An adjusting force of a drive member oriented transversely to the longitudinal chain direction and formed as a thrust bolt can be introduced into the compression-resistant chain in such a way that the chain links can be moved into a compression-resistant position and can be returned from that position by means of a sprocket wheel. According to the invention, the thrust bolt engages between the neighboring swivel elements in the area of concave arc contours forming partial surfaces of the two bearing surfaces.

The invention relates to a compression-resistant drive chain for an adjusting device according to the preamble of claim 1.

An adjusting device disclosed in DE 33 15 779 C2 has a drive with a compression-resistant drag link chain having chain links that are provided with external connectors and are connected by hinge pins and lock pins transversely to the longitudinal chain direction. By means of a sprocket wheel provided for driving the chain, an advancing force is introduced at these hinge pins and, subsequently, the lock pins provided for stiffening the chain can be moved into the locking position, respectively, by means of a guiding device acting transversely to the advancing direction. In the solution proposed in DE 10 46 422 there are also lock pins that can be moved transversely to the advancing direction of the chain by means of a guiding device so that the chain assumes a compression-resistant position of use only after the movement of the lock pins has taken place.

In a block chain according to DE 18 55 588 U a conveying device for horizontally conveying goods is proposed wherein the tractive force of a drive wheel can be transmitted by means of hinge pins that connect the links of the chain, respectively, but the system as a whole is not designed for compression-resistant adjusting devices. According to DE 199 83 305 T1 a connecting part is proposed that has an internally positioned chain that is provided with an envelope forming a channel-shaped elongate section for imparting rigidity. Accordingly, these compression-resistant drive chains require a disadvantageously large mounting space and are exposed to high wear as a result of a plurality of greatly loaded hinge parts.

According to EP 1 383 882 A2 a drive chain is disclosed in which swivel elements that have complementary bearing surfaces are configured for introducing an adjusting force in the area of arc-shaped sliding surfaces that can contact one another in such a way that, when using this compression-resistant chain in a lifting device, a reversal in the area of the sprocket wheel is possible.

The invention concerns the problem of providing a compression-resistant drive chain whose swivel elements provided with arc-shaped sliding surface pairs for movement reversal are mountable in a chain structure that requires fewer individual parts so that the chain structure enables, because of minimal friction in the area of the component connections, a wear-free, low maintenance utilization with long-term stability.

The invention solves this problem with a drive chain having the features of claim 1. With regard to important additional embodiments, reference is being had to claims 2 to 8.

The drive chain according to the invention has in the area of the two swivel elements a concave arc contour for directly forming the sliding surface pairs with the intermediately arranged thrust bolts. With this combination of swivel elements with a thrust bolt directly engaging therebetween, a direct force introduction and force transmission are possible so that the chain as a whole can be constructed of fewer individual parts and a simple module like a pushpull chain is achieved that can be used substantially in any type of application in adjusting, lifting, and positioning devices.

This direct force and movement introduction is controlled with a reduced number of sliding surfaces that are loaded during the adjusting movement in such a way that only minimal friction occurs in their area when optimal support conditions are provided. Accordingly, the simplified pushpull chain system is essentially of a wear-free and low-maintenance configuration and can be used with long-term stability. This drive chain can be used in particular as a high-performance chain for adjusting devices in automatic manufacturing and assembly lines wherein adjusting movements can be performed with more than 300 mm per second in the advancing direction and directional and load changes can be carried out at a stroke number of more than 60 strokes per minute.

Further details and advantageous embodiments of the invention will result from the following description and the drawing in which one embodiment of the drive chain according to the invention is illustrated. The drawings show in:

FIG. 1 a side view of the drive chain according to the invention;

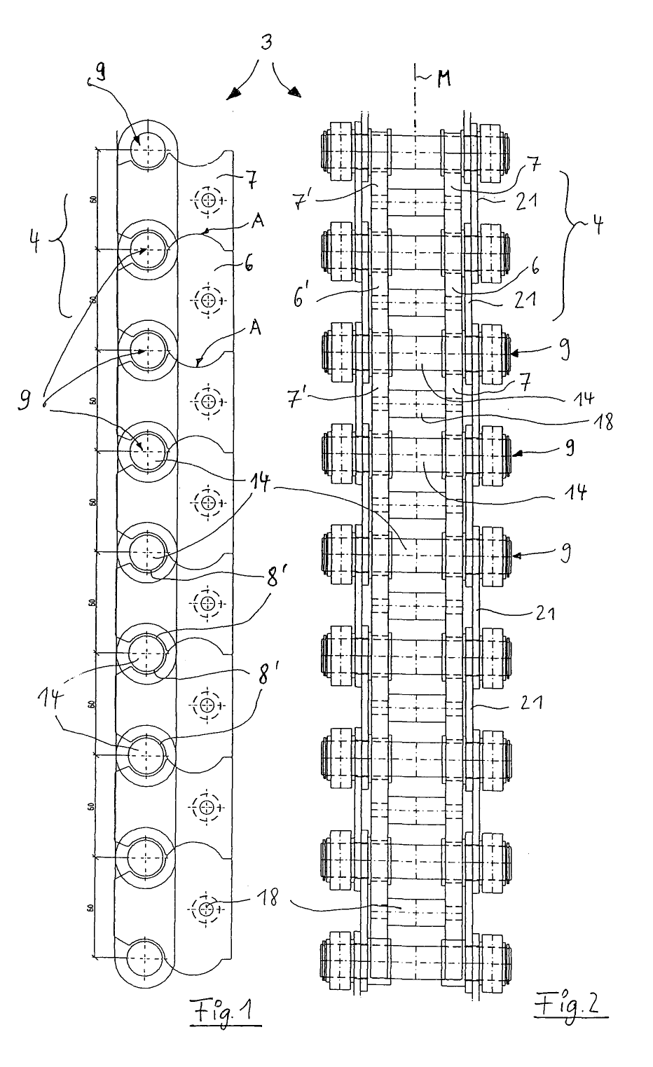

FIG. 2 a front view of the drive chain according to FIG. 1;

FIG. 3 an enlarged side view of a partial area of the compression-resistant drive chain in a working position;

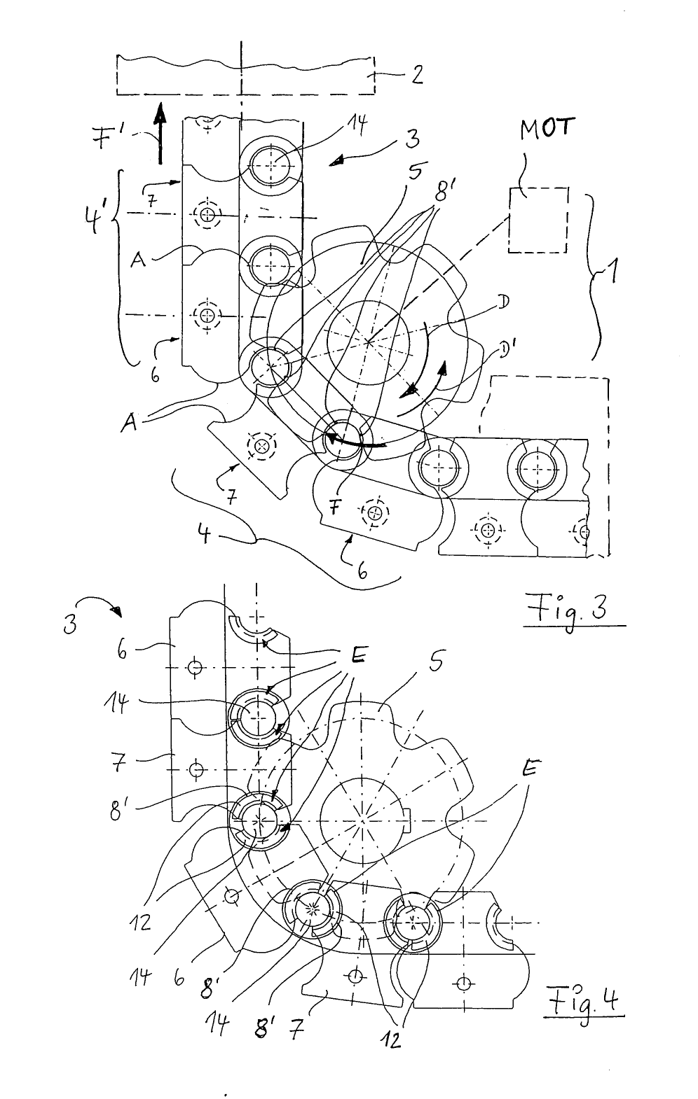

FIG. 4 a side view similar to FIG. 3 with sliding elements provided in the area of the thrust bolts;

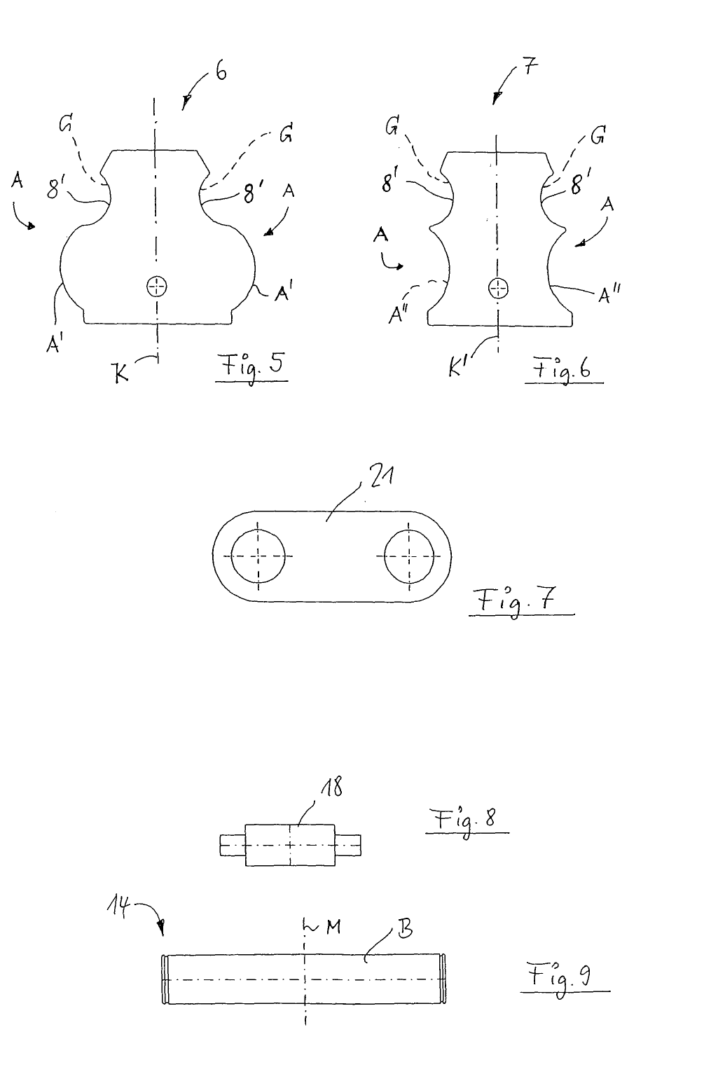

FIG. 5 an individual illustration of a first swivel element for the chain link forming the drive chain;

FIG. 6 an individual illustration of a second swivel elements of the drive chain;

FIG. 7 an individual illustration of a connecting plate for connecting the swivel elements in the area of the thrust bolt;

FIG. 8 an individual illustration of a spacer provided between the swivel elements;

FIG. 9 an individual illustration of a thrust bolt provided between the swivel elements;

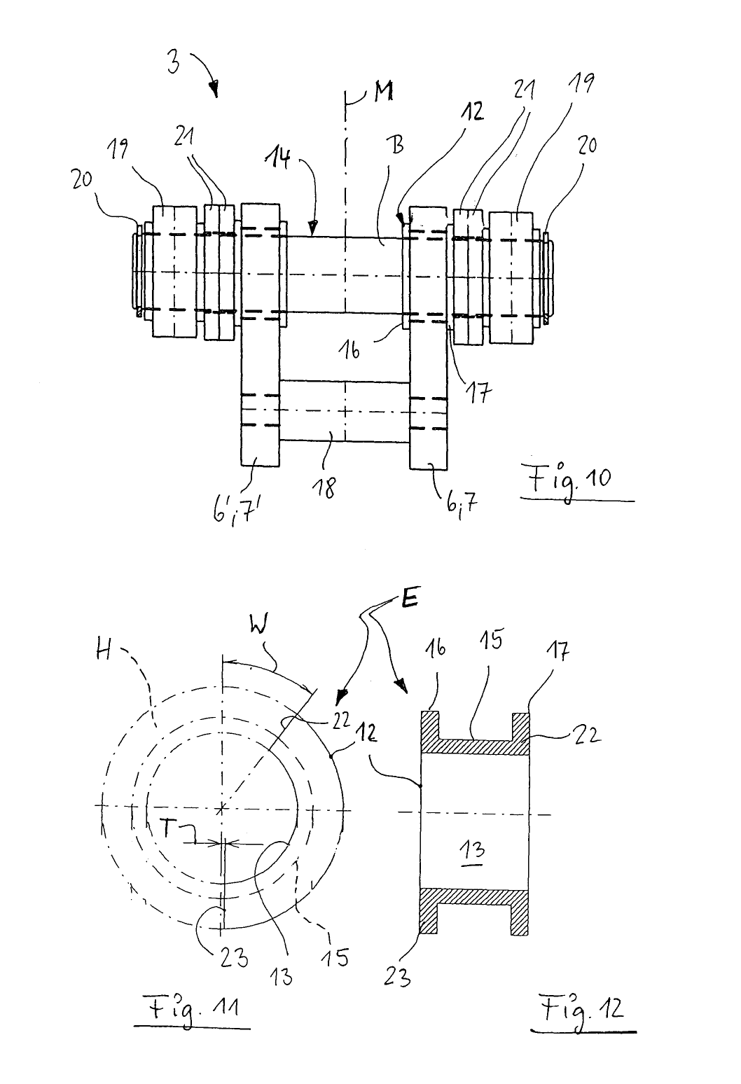

FIG. 10 a front view of the drive chain according to FIG. 1;

FIG. 11 a side view of the sliding element provided in the area of the arc contour in the form of a sleeve segment; and

FIG. 12 a side view of the sleeve segment according to FIG. 11.

In FIG. 1, a drive chain is illustrated that is referenced as a whole by 3; by means of the drive chain an adjusting device in the form of a lifting table or similar working device, referenced generally by 1 in FIG. 3, is movable by continuous adjustment. The drive chain 3 has sequentially arranged chain links 4 that are movable by means of a sprocket wheel 5 driven by motor M into a compression-resistance lifting position (arrow F′, chain links 4′).

The illustration according to FIG. 2 shows that the drive chain 3 has several chain links 4, 4′ connected by external connecting plates 21 and transversely to the longitudinal chain direction M in the area of thrust bolts 14 as drive members 9; the chain links are comprised of at least two swivel elements 6 and 7 with bearing surfaces A that have a complementary shape at least over portions thereof in the longitudinal chain direction M. These bearing surfaces A, according to EP 1 382 882 A2, have sliding surfaces G that extend at least over portions thereof as an arc contour 8. In the area of these sliding pairs, an adjusting force F of the sprocket wheel 5 (direction of rotation upon stroke: D) can be introduced into the thrust bolts 14 extending transversely to the longitudinal chain direction M so that the chain links identified in FIG. 3 at 4′ are moved by the sprocket wheel 5 into the compression-resistant position and, from this position, can be returned by reversal of rotational direction (D′) of the sprocket wheel 5.

In the embodiment of the drive chain 3 according to the invention, the thrust bolt 14 provided for each chain link 4, 4′ has a mounting position in which it engages directly between the adjacent swivel elements 6 and 7. This engagement position is defined by the concave arc contours 8′ that form partial surfaces of the two bearing surfaces A. The individual illustrations according to FIG. 5 and FIG. 6 show that the swivel element 6 is mirror-symmetrical to the longitudinal center plane K with a contour that is comprised of the concave arc contour 8′ as a sliding surface G and the convex bearing surface A′. The respective correlated swivel element 7 has mirror-symmetrical to the longitudinal center plane K′ in the area of the sliding surface G forming the arc contour 8′ as well as in the area of the correlated bearing surface A″ concave contour areas, respectively, so that the engagement and contact conditions shown in FIG. 1 result.

In functional use of this compression-resistant drive chain 3 according to FIG. 3 or FIG. 4, the driving thrust bolt 14 acts in such a way that in the advancing direction as well as in the return direction the circumferential surface B of the thrust bolt 14 rests at least partially against one of the two concave arc contours 8′ that are opposed to one another relative to the longitudinal chain direction M and, in this position, sliding surface pairs are defined in which the adjusting force F of the driving sprocket wheel 5 is reversible within the chain 3.

The view according to FIG. 2 shows that the thrust bolt 14 connected by the terminal connecting plates 21, respectively, has correlated therewith swivel element pairs 6, 6′; 7, 7′, respectively, that form two parallel rows in the longitudinal chain direction so that the driving sprocket wheel 5 can be placed against at least one of the thrust bolts between these two rows of swivel elements. It is conceivable also to provide only one row of swivel elements 6, 7 that are penetrated by the thrust bolt 14 in such a way that on the thrust bolt the force is applied externally (not illustrated).

In this way, a drive chain 3 is provided that, in an advantageous construction from identical parts, has chain links 4 that are comprised of only a few individual parts. The swivel elements 6, 7 provided for force uptake and reversal the drive moment are provided in the area of the concave arc contour 8′ with a receptacle that receives the thrust bolt 14 substantially in a wear-free and friction-free way. It is conceivable in this connection that the thrust bolt 14 that is circumferentially fine-machined is supported on a hardened surface provided in the area of the arc contour 8′ in such a way that the pressure forces F introduced directly and areally into the arc contour 8′ are deflected with minimal friction.

The illustration according to FIG. 4 shows that in the area of the sliding surface pairs sliding elements E matched to the course of the arc contour 8′, respectively, are provided between the thrust bolt 14 and the swivel element 6, 7.

In an expedient embodiment, the sliding elements E are in the form of sleeve segments 12, respectively (FIG. 11, FIG. 12). These sleeve segments 12 that are formed as partial sections of a sleeve part H (FIG. 11) illustrated in dash-dotted lines have, on the one hand, an inner circular arc-shaped wall part 13 that can be placed directly onto the thrust bolt 14. On the other hand, the sleeve segments 12 are provided with an external U-shaped profile that is delimited by legs 16, 17 that can be placed laterally against the swivel elements 6, 7 and whose basic arc 15 can be placed against the concave arc contour 8′ of the swivel element 6, 7, respectively. For an optimal support of the sleeve segments 12 in the reversal phase (FIG. 3, FIG. 4), they are provided with an inner end face 22 having a slant angle W and an eccentric (T) outer end face 23.

In FIG. 10, the drive chain 3 is shown in an end view that illustrates the serial arrangement of the individual components on the thrust bolt 14. In an expedient embodiment, for stabilizing the drive chain 3 a spacer 18 (FIG. 8) is provided, respectively, between the swivel elements 6, 6′; 7, 7′ that are positioned opposite one another in pairs; the spacer extends transversely to the longitudinal chain direction M. For supporting the drive chain 3 in the adjusting device 1, not illustrated in detail, externally adjacent to the connecting plates 21 (FIG. 7) support parts 19 are provided on the thrust bolt 14, respectively, that are in the form of ball bearings or the like which, in turn, are secured by external coupling rings or the like 20 in the mounted position.

What is claimed is:

1-8. (canceled)

9. A compression-resistant drive chain for an adjusting device, the drive chain comprising:
chain links;
connecting plates pivotably connecting the chain links to one another;
wherein the chain links are comprised of swivel elements having bearing surfaces that are at least partially complementary in a longitudinal chain direction and have sliding surfaces that form at least over portions thereof an arc contour, respectively;
a sprocket wheel;
thrust bolts oriented transversely to the longitudinal chain direction, wherein the sprocket wheel acts through the thrust bolts on the chain links and wherein the thrust bolts engage between two of said swivel elements neighboring one another, respectively, in an area of the arc contours, wherein two of the arc contours are arranged opposed to one another for receiving the thrust bolts, respectively;
wherein an adjusting force of the sprocket wheel is introduced through the thrust bolts into the drive chain in such a way that the chain links are moved into a compression-resistant position and returned from the compression-resistant position.

10. The compression-resistant drive chain according to claim 9, wherein the thrust bolts, in an advancing direction and in a return direction of the drive chain, each define a sliding surface pair, wherein the thrust bolts each have a circumferential surface resting at least partially against one of said two opposed arc contours, wherein the arc contours are concave, and wherein the adjusting force of the sprocket wheel is reversible within the drive chain in said sliding surface pair.

11. The compression-resistant drive chain according to claim 10, wherein the thrust bolts have ends connected by the connecting plates, wherein the swivel elements are arranged in pairs so as to form two parallel rows in the longitudinal chain direction, wherein the sprocket wheel is placed between the two rows of the swivel elements against at least one of the thrust bolts transversely to the longitudinal chain direction.

12. The compression-resistant drive chain according to claim 10 wherein said two opposed arc contours provide a substantially wear-free and friction-free support for the thrust bolts, respectively.

13. The compression-resistant drive chain according to claim 10, further comprising sliding elements, matched to a shape of the arc contours, provided in the area of the sliding surface pair between the thrust bolts and the swivel elements, respectively.

14. The compression-resistant drive chain according to claim 13, wherein the sliding elements are sleeve segments each having an inner circular arc-shaped wall surface placed onto the thrust bolts, respectively, and each having an outer U-shaped profile comprising a basic arc placed against the arc contour and further comprising legs placed laterally against the swivel elements.

15. The compression-resistant drive chain according to claim 10 wherein the bearing surfaces of the swivel elements are placed against one another in the longitudinal chain direction and have partial areas, respectively, that adjoin in a common plane the arc contours and have a complementary shape, which partial areas in the compression-resistant position of the drive chain are placed against one another as a positive-locking profile.

16. The compression-resistant drive chain according to claim 9, further comprising spacers that connect the swivel elements in a direction transversely to the longitudinal chain direction.
